(19) United States
(12) Patent Application Publication
(10) Pub. No.: US 2020/0028637 A1
(43) Pub. Date: Jan. 23, 2020

(54) SPECTRUM UTILIZATION FOR STANDALONE NB-IOT CARRIERS

(71) Applicant: NOKIA TECHNOLOGIES OY, Espoo (FI)

(72) Inventors: Gunter Wolff, Laupheim (DE); Man Hung Ng, Wiltshire (GB); Andreas Kratzert, Ulm (DE); Petri Juhani Vasenkari, Turku (FI)

(21) Appl. No.: 16/496,910

(22) PCT Filed: Mar. 24, 2017
(86) PCT No.: PCT/EP2017/057108

§ 371 Date: Sep. 23, 2019

(51) Int. Cl. H04L 5/00

(52) U.S. Cl. CPC H04L 5/003; H04L 5/0005

(57) ABSTRACT

There is provided method comprising: transmitting by a first entity a first carrier signal of a plurality of carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

### FIELD

The present application relates to a method, apparatus, system and computer program and in particular but not exclusively to a method and apparatus for transmitting or receiving at least one carrier signal.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, user devices or mobile stations are referred to as user equipment (UEs). Currently 3GPP is also developing the new 5G standards, known as New Radio. Such development is taking place, for example, in the Radio Access Network (RAN) working group.

Narrowband internet of things (NB-IoT) is a technology which allows for low data rate communication between objects. The subcarriers and physical time structure used in NB-IoT are similar to those used by LTE and therefore these two methods of communication can be combined. The combined system can benefit from orthogonality, if LTE and NB-IoT are aligned in frequency and time domain, and hence interference between NB-IoT and LTE can be kept reasonably low without filtering. However, because of restrictions in the offset to the channel raster, in some cases orthogonality between standalone NB-IoT carriers can't be provided and higher interference may occur, which may be problematic.

### SUMMARY OF THE INVENTION

According to first aspect, there is provided method comprising: transmitting by a first entity a first carrier signal of a plurality of standalone carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

The method may further comprise transmitting by the first entity the second carrier signal.

According to a second aspect, there is provided a method comprising: performing a search for at least one carrier signals using a channel raster; receiving at least a first carrier signal of a plurality of standalone carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprise a plurality of subcarriers of a defined bandwidth, and the first frequency and the second frequency differ by an amount substantially equal to a multiple of the defined bandwidth.

In some embodiments of the first and/or second aspect, the first threshold distance may be the same as the second threshold distance.

In some embodiments of the first and/or second aspect, the second frequency may be offset from a second channel raster point by a second amount which is greater than zero.

In some embodiments of the first and/or second aspect, the first frequency may be offset from the first channel raster point by about +2.5 kHz and the second frequency may be offset from the second channel raster point by about −2.5 kHz.

In some embodiments of the first and/or second aspect, the first frequency may be offset from the first channel raster point by about +5 kHz and the second frequency is offset from the second channel raster point by about −5 kHz.

In some embodiments of the first and/or second aspect, the plurality of carrier signals may comprise a third carrier signal adjacent the second carrier signal and centered at a third frequency within a third threshold distance from a third channel raster point.

In some embodiments of the first and/or second aspect, the plurality of carrier signals comprises a sequence of carrier signals, where the sequence of carrier signals uses a repeating sequence of offsets from the channel raster points on a frequency spectrum.

In some embodiments of the first and/or second aspect, wherein at least one of the plurality of carrier signals is centered at a point of the channel raster.

In some embodiments of the first and/or second aspect, the first frequency may be offset from the first channel raster point by about +5 kHz, the second frequency is centered substantially at the second channel raster point, and the third frequency is offset from the third channel raster point by about −5 kHz.

In some embodiments of the first and/or second aspect, the plurality of carrier signals comprises a plurality of sets of carrier signals, each set comprising three carrier signals having a relative arrangement on a frequency spectrum matching a relative arrangement of the first carrier signal, the second carrier signal, and the third carrier signal.

In some embodiments of the first and/or second aspect, the plurality of carrier signals may comprise a first set of carrier signals comprising the first carrier signal and the second carrier signal; the plurality of carrier signals may comprise a second set of carrier signals adjacent the first set and comprising subcarriers of a second defined bandwidth different to the defined bandwidth, there may be at least two channel raster points between the first set of carrier signals and the second set of carrier signals.

In some embodiments of the first and/or second aspect, the first carrier signal and the second carrier signal may be anchor carrier signals.

In some embodiments of the first and/or second aspect, the first carrier signal may be an anchor carrier signal, and the second carrier signal is a non-anchor carrier signal, the first threshold distance may be smaller than the second threshold distance.

In some embodiments of the first and/or second aspect, the first frequency may be offset from the first channel raster point and the second frequency is offset from the second channel raster point such that there is no guardband between the carrier signals.

In some embodiments of the first and/or second aspect, the second threshold is −50 kHz and +45 kHz from the second channel raster point, wherein the second frequency is positioned at a multiple of 5 kHz from the boundaries of the second threshold.

In some embodiments of the first and/or second aspect, the plurality of carrier signals are arranged in a sequence, wherein each of the plurality of carrier signals is offset from its nearest channel raster point by an amount less than a defined threshold.

Any of the methods above may be performed by an apparatus.

A computer program comprising program code means adapted to perform the method may also be provided. The computer program may be stored and/or otherwise embodied by means of a carrier medium.

It should be appreciated that any feature of any aspect may be combined with any other feature of any other aspect.

According to a third aspect, there is provided a computer program product for a computer, comprising software code portions for performing the steps of the first aspect or second aspect when the program is run on the computer.

According to a fourth aspect, there is provided an apparatus comprising: at least one processor and at least one memory including computer program code, the at least one memory and the computer program code configured to, with the at least one processor, cause the apparatus at least to: transmit a first carrier signal of a plurality of standalone carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

In some embodiments, the at least one memory and the computer program code are configured to, with the at least one processor, cause the apparatus to transmit the second carrier signal.

According to a fifth aspect, there is provided an apparatus comprising: at least one processor and at least one memory including computer program code, the at least one memory and the computer program code configured to, with the at least one processor, cause the apparatus at least to: perform a search for at least one carrier signals using a channel raster; receive at least a first carrier signal of a plurality of standalone carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprise a plurality of subcarriers of a defined bandwidth, and the first frequency and the second frequency differ by an amount substantially equal to a multiple of the defined bandwidth.

In some embodiments of the fourth and/or fifth aspect, the first threshold distance may be the same as the second threshold distance.

In some embodiments of the fourth and/or fifth aspect, the second frequency may be offset from a second channel raster point by a second amount which is greater than zero.

In some embodiments of the fourth and/or fifth aspect, the first frequency may be offset from the first channel raster point by about +2.5 kHz and the second frequency may be offset from the second channel raster point by about −2.5 kHz.

In some embodiments of the fourth and/or fifth aspect, the first frequency may be offset from the first channel raster point by about +5 kHz and the second frequency is offset from the second channel raster point by about −5 kHz.

In some embodiments of the fourth and/or fifth aspect, the plurality of carrier signals may comprise a third carrier signal adjacent the second carrier signal and centered at a third frequency within a third threshold distance from a third channel raster point.

In some embodiments of the fourth and/or fifth aspect, the plurality of carrier signals comprises a sequence of carrier signals, where the sequence of carrier signals uses a repeating sequence of offsets from the channel raster points on a frequency spectrum.

In some embodiments of the fourth and/or fifth aspect, wherein at least one of the plurality of carrier signals is centered at a point of the channel raster.

In some embodiments of the fourth and/or fifth aspect, the second threshold is −50 kHz and +45 kHz from the second channel raster point, wherein the second frequency is positioned at a multiple of 5 kHz from the boundaries of the second threshold.

In some embodiments of the fourth and/or fifth aspect, the first frequency may be offset from the first channel raster point by about +5 kHz, the second frequency is centered substantially at the second channel raster point, and the third frequency is offset from the third channel raster point by about −5 kHz.

In some embodiments of the fourth and/or fifth aspect, the plurality of carrier signals comprises a plurality of sets of carrier signals, each set comprising three carrier signals having a relative arrangement on a frequency spectrum matching a relative arrangement of the first carrier signal, the second carrier signal, and the third carrier signal.

In some embodiments of the fourth and/or fifth aspect, the plurality of carrier signals may comprise a first set of carrier signals comprising the first carrier signal and the second carrier signal; the plurality of carrier signals may comprise a second set of carrier signals adjacent the first set and comprising subcarriers of a second defined bandwidth different to the defined bandwidth, there may be at least two channel raster points between the first set of carrier signals and the second set of carrier signals.

In some embodiments of the fourth and/or fifth aspect, the first carrier signal and the second carrier signal may be anchor carrier signals.

In some embodiments of the fourth and/or fifth aspect, the first carrier signal may be an anchor carrier signal, and the second carrier signal is a non-anchor carrier signal, the first threshold distance may be smaller than the second threshold distance.

In some embodiments of the fourth and/or fifth aspect, the first frequency may be offset from the first channel raster point and the second frequency is offset from the second channel raster point such that there is no guardband between the carrier signals.

In some embodiments of the fourth and/or fifth aspect, the plurality of carrier signals are arranged in a sequence, wherein each of the plurality of carrier signals is offset from its nearest channel raster point by an amount less than a defined threshold.

According to a sixth aspect, there is provided an apparatus comprising: means for transmitting a first carrier signal of a plurality of standalone carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

According to a seventh aspect, there is provided an apparatus comprising: means for performing a search for at least one carrier signals using a channel raster; receiving at least a first carrier signal of a plurality of standalone carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprise a plurality of subcarriers of a defined bandwidth, and the first frequency and the second frequency differ by an amount substantially equal to a multiple of the defined bandwidth.

### BRIEF DESCRIPTION OF DRAWINGS

Embodiments will now be described, by way of example only, with reference to the accompanying Figures in which:

FIG. 1 shows a schematic diagram of an example communication system comprising a plurality of base stations and a plurality of communication devices;

FIG. 2 shows a schematic diagram of an example mobile communication device;

FIG. 3 illustrates a frequency spectrum showing NB-IoT and LTE carriers;

FIG. 4 illustrates a frequency spectrum showing two adjacent carrier signals;

FIG. 5 illustrates a frequency spectrum showing two adjacent carrier signals;

FIG. 6 illustrates a frequency spectrum showing three adjacent carrier signals;

FIG. 7 illustrates a frequency spectrum showing four adjacent carrier signals;

FIG. 8 illustrates a frequency spectrum showing two adjacent carrier signals;

FIG. 9 illustrates a frequency spectrum showing two adjacent carrier signals;

FIG. 10 illustrates an example method that may be performed to determine the frequencies of the carrier signals to be transmitted;

FIG. 11 illustrates an example method that may be performed to search, locate and receive carrier signals;

FIG. 12 illustrates an example method that may be performed at a transmitting device of the apparatus;

FIG. 13 shows a schematic diagram of an example control apparatus; and

FIG. 14 illustrates a frequency spectrum showing four adjacent carrier signals.

### DETAILED DESCRIPTION

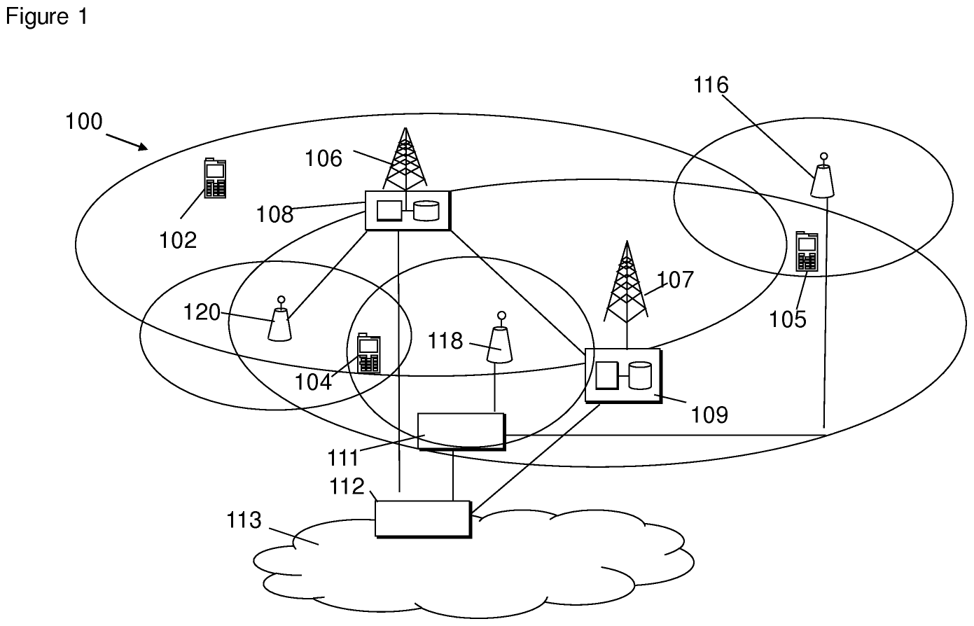

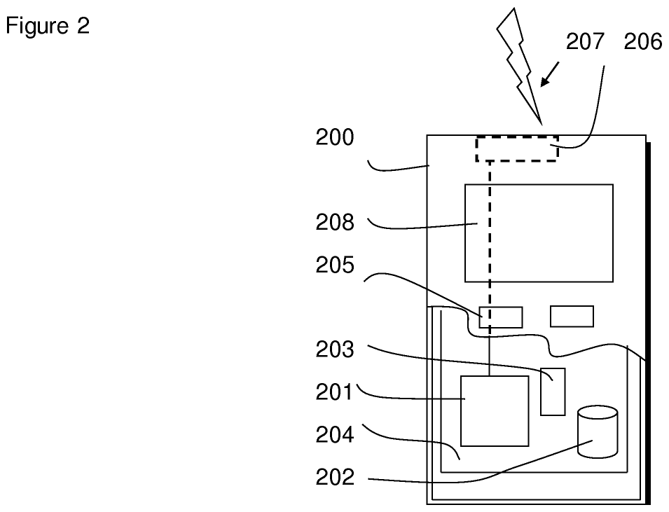

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. A base station is referred to as an eNodeB (eNB) in LTE. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the eNB is in communication with a system architecture evolution gateway (SAE-GW) and a mobility management entity (MME), which entities may also be pooled meaning that a plurality of these nodes may serve a plurality (set) of eNBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

The devices 102, 104, 105, described above may also be configured to send and receive communications in accordance with Narrowband Internet of Things (NB-IoT) in addition to sending and receiving LTE communications. The devices may be UE devices and may exchange NB-IoT communications with base stations 116, 118, and 120 or may exchange NB-IoT communications with other UE devices.

A user device (user terminal, user equipment (UE) or mobile station) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network. By way of illustrative example, the various example implementations or techniques described herein may be applied to various user devices, such as machine type communication (MTC) user devices, enhanced machine type communication (eMTC) user devices, Internet of Things (IoT) user devices, and/or narrowband IoT user devices.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans.

In an example implementation, a user device or UE may be a UE/user device with ultra-reliable low latency communications (URLLC) applications. A cell (or cells) may include a number of user devices connected to the cell, including user devices of different types or different categories, e.g., including the categories of MTC, NB-IoT, URLLC, or other UE category.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

A possible UE will now be described in more detail with reference to FIG. 2 showing a schematic, partially sectioned view of a UE 200. An appropriate UE may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A UE may provide, for example, communication of data for carrying communications such as voice, electronic mail (email), text message, multimedia, and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The UE 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the mobile device.

A UE is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a UE may comprise appropriate connectors (either wired or wireless) to other devices and/or for connecting external accessories, for example hands-free equipment, thereto.

It would be understood by the person skilled in the art that a UE may not include all of the features discussed above with respect to FIG. 2, but may be simpler than the example presented. A UE need not include, for example, a display 208 or a speaker. It should be appreciated that in some embodiments, a device with communications ability may be used.

Narrowband internet of things (NB-IoT) is a technology which allows for low data rate communication between objects. The downlink (DL) communications as well the uplink (UL) communications are orthogonal frequency division multiplexed (OFDM) signals with 180 kHz bandwidth. Each DL signal consists of 12 subcarriers, each of which is 15 kHz wide. This physical time structure is the same as the arrangement of subcarriers in an LTE physical resource block (PRB), which also comprises 12 subcarrier, each of which is 15 kHz wide. The UL signal for NB-IoT may consist of 12 subcarriers, each of which is 15 kHz wide, or 48 subcarriers, each of which is 3.75 KHz wide.

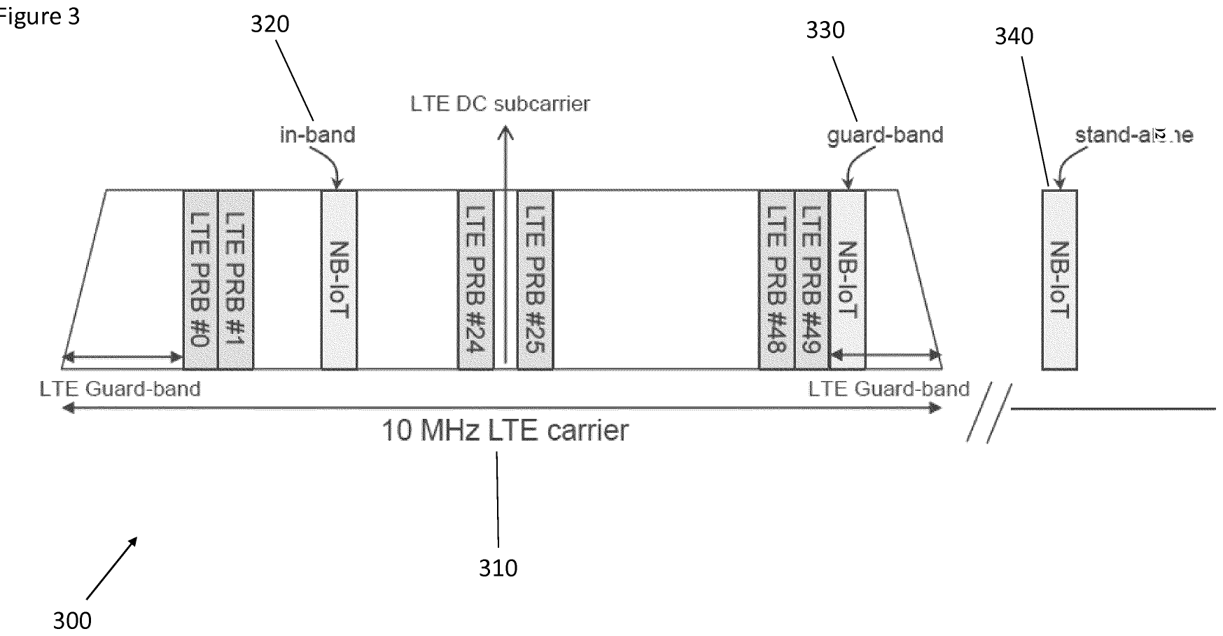

There are 3 modes of operation for NB-IoT: standalone, inband or guardband. Reference is made to FIG. 3, which illustrates examples of each of these three possible modes.

FIG. 3 shows an LTE carrier signal 310. The carrier signal has a bandwidth of 10 MHz. Thus, it is possible for an LTE operator to deploy NB-IoT carrier signals within an LTE carrier by allocating one of the physical resource blocks (PRB), which also have a width of 180 KHz, to an NB-IoT carrier. This mode of operation is referred at as an in-band operation, and is illustrated in FIG. 3, by the NB-IoT in-band carrier signal 320.

Instead of allocating one of the PRBs of the LTE carrier for NB-IoT, an NB-IoT signal 330 may be implemented in the guardband at the side of the LTE signal. The guardband is an unused part of the spectrum at the edge of an LTE carrier signal, which exists to prevent interference between the LTE carrier signal and any adjacent signal, e.g. a further LTE carrier signal.

A third option for implementing NB-IoT is standalone deployment. Unlike inband or guardband operation, standalone deployment utilizes bandwidth that is not reserved by the existing LTE network. As shown in FIG. 3, a standalone NB-IoT signal 340 may be located in an unused part of the spectrum away from the LTE carrier.

For the standalone communication mode, two requirements regarding the positioning of the NB-IoT must be considered.

Firstly, each NB-IoT carrier should be centred on a point in the channel raster. The channel raster is the steps or frequencies that can be used by a communication device. For the NB-IoT system, the channel raster is 100 kHz (100 kHz frequency steps) and therefore the centre of each NB-IoT carrier should be separated from the centre of neighbouring NB-IoT carriers by a multiple of 100 kHz. This requirement results from the search process that is performed by a UE when it is turned on and searches for NB-IoT carriers. The UE is configured to only search for carriers on the channel raster which means in that, in this example, the UE only searches for carriers centred on frequencies that are multiples of 100 kHz. Therefore, the NB-IoT carriers must be centred close to a point in the 100 kHz channel raster.

Secondly, the subcarriers of each NB-IoT carrier, the guard band of which overlaps with the guard band of another NB-IoT (or LTE) carrier, should be aligned on a common grid with a subcarrier spacing of 15 kHz, which is used by both NB-IoT and LTE. In other words, the two adjacent NB-IoT carriers should be separated by integer multiples of 15 kHz. As explained above, NB-IoT signals are OFDM signals. OFDM signals are a set of frequency multiplexed signals with the exact minimum frequency spacing needed to make them orthogonal so that they do not interfere with one another. This requirement is met for subcarriers within an NB-IoT carrier, since this 15 kHz spacing is part of the NB-IoT standard. However, if the distance between two adjacent NB-IoT carriers is not chosen to be a multiple of 15 kHz, the subcarriers of one NB-IoT carrier will not be orthogonal with the subcarriers of the other NB-IoT carrier. This leads to interference between two adjacent NB-IoT carrier signals, if the guardband of any carrier overlaps with another carrier.

To satisfy both of these requirements, one proposal has been to insert a 100 kHz guardband onto each carrier signal so that the distance between the centre of adjacent carriers is 300 kHz. The distance of 300 kHz satisfies the first requirement of being centred on a point in the channel raster, since 300 kHz is a multiple of 100 kHz. The distance of 300 kHz also satisfies the second requirement of aligning the subcarriers on the 15 kHz grid, since 300 kHz is a multiple of 15 kHz.

However, using a spacing of 300 kHz in standalone mode means that a relatively large amount of unused bandwidth is present between each of two adjacent carriers. This may be a waste of bandwidth in the spectrum.

Some embodiments may address this issue to provide a mechanism for keeping the level of interference low and reducing the amount of wasted space in the spectrum.

It is not necessary for the centre of each NB-IoT carrier to fall exactly on a point in the channel raster. A certain amount of deviation from the point is permitted, whilst still allowing the UE to locate the carrier during initialisation. For example, in NB-IoT inband and guardband modes of operation, up to ±7.5 kHz offset for an anchor carrier is permitted, and up to ±47.5 kHz offset is permitted for a non-anchor carrier. An anchor carrier is an NB-IoT carrier that is intended for facilitating UE's initial synchronization. For standalone operation, an offset of up to ±7.5 kHz from each point in the channel raster should also be permitted. Some embodiments may control the frequency of transmission of NB-IoT carrier signals so that these requirements are met.

The allowable threshold (e.g. 7.5 kHz) from the channel raster points results from the detection tolerance of the UE. The UE will search at the channel raster points, but has a certain detection tolerance and can detect carrier signals within a threshold of the searched channel raster points.

According to some embodiments of the application, there is provided a device for transmitting carrier signals in standalone mode. The device may transmit a first signal, which is centered at a first frequency that deviates from a first channel raster point by a first amount. The first channel raster point is the channel raster point in the channel raster that is closest to the first frequency. This first amount may be less than a threshold or limit (e.g. 7.5 kHz) required for a communication system (e.g. a UE) to search for and identify the first signal. The device may also transmit a second signal, which deviates from a second channel raster point by a second amount. Alternatively, the second signal may be transmitted by a different device. The second amount may likewise be less than a threshold required to identify the second signal. Thus, the deviation from the channel raster points for both signals is small enough to satisfy the requirement that the carrier signals be approximately centered on the channel raster points.

The first signal and the second signal may be anchor carrier signals. Alternatively, one may be an anchor carrier signal and another may be a non-anchor carrier signal.

The first amount and second amount are chosen such that the frequency difference between the centre point of the first signal and the centre point of the second signal is a multiple of the bandwidth of the subcarriers of the first signal and second signal. The multiple may be integer multiple. The bandwidth of the subcarriers may also interchangeably be referred to as the subcarrier spacing.

The existing standalone NB-IoT placement utilises an M_{DL}=−0.5 standalone NB-IoT placement. The M_{DL} number is defined as the offset of NB-IoT Downlink channel number to E-UTRA Absolute Radio Frequency Channel Number. In contrast to the standalone placement, the inband or guardband placement utilises an M_{DL} that is an integer in the range of −10 to 9. Therefore, although the inband and guardband modes may utilise an offset from the channel raster, the same set of offsets that could be used in inband and guardband mode may not be used in standalone mode due incompatibilities with the existing (M_{DL}=−0.5) standalone placement.

Because the 15 kHz subcarrier grid for guardband and inband NB-IoT is related to the “hosting” LTE, which contains an empty DC subcarrier and therefore comprises an odd number of subcarriers, and NB-IoT has an even number of subcarriers (12), the spacing between LTE and NB-IoT follows the 15 kHz·(2N+1)/2 rule, where the best match with the channel raster is ±2.5 kHz. Standalone NB-IoT was set up for exact match with the channel raster, since no hosting LTE is present to align with the subcarrier grid thereof.

Although, in the following description of the embodiments, the protocol used is NB-IoT and therefore the requirements as described above, e.g. the carrier must be centred within a threshold distance of a point on a 100 kHz channel raster and the subcarriers must be aligned with the 15 kHz subcarrier grid, are relevant. However, it would be understood by the person skilled in the art that not all embodiments are so limited, and that in some embodiments different protocols may be used having channel rasters of subcarrier girds of different step sizes from the step sizes used in the NB-IoT protocol.

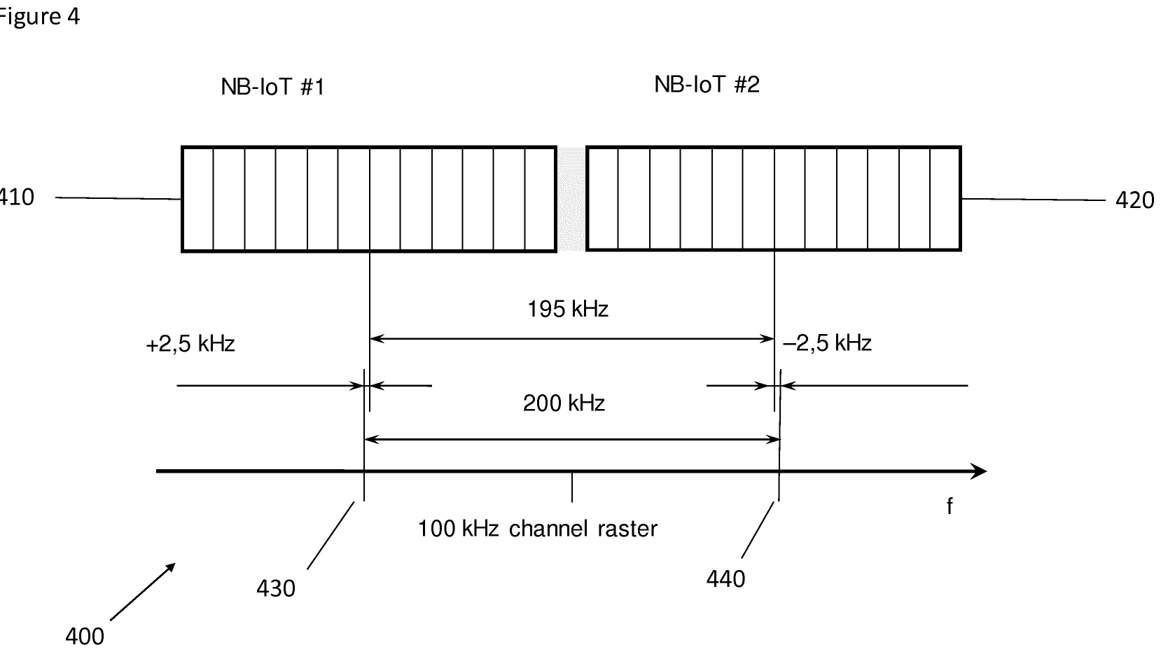

Reference is made to FIG. 4, which shows an example of the relative frequencies at which two carrier signals may be transmitted. The figure shows a first carrier signal 410, and a second carrier signal 420. The first carrier signal 410 is positioned close to a first point 430 in the channel raster, with its centre offset from the first point 430 by a first amount which is within the allowable threshold. In this example, the first amount is +2.5 kHz, which is within the allowable threshold for NB-IoT of ±7.5 kHz. The second carrier signal 420 is positioned close to a second point 440, with its centre offset from the second point 440 by a second amount which is within the allowable threshold. In this example, the second amount is −2.5 kHz, which is within the allowable threshold for NB-IoT of ±7.5 kHz. Thus in this example, the requirement that each carrier must be positioned within an allowable threshold from a point in the channel raster is met.

The offsets from the points in the channel raster are such that the distance between the centre of the first carrier signal 410 and the centre of the second carrier signal 420 is a multiple of the bandwidth allocated for each subcarrier. In this example, the distance between these centres is 195 kHz, which is a multiple of 15 kHz, the bandwidth allocated for each subcarrier in both NB-IoT and LTE. Therefore, both of the two requirements described above are met.

Therefore, in some embodiments the offsets of +2.5 kHz and −2.5 kHz may be used for a sequence of adjacent carrier signals, where a first carrier signal in the sequence has an offset of +2.5kHz from its nearest channel raster point and the second carrier signal in the sequence has an offset of −2.5kHz from its nearest channel raster point.

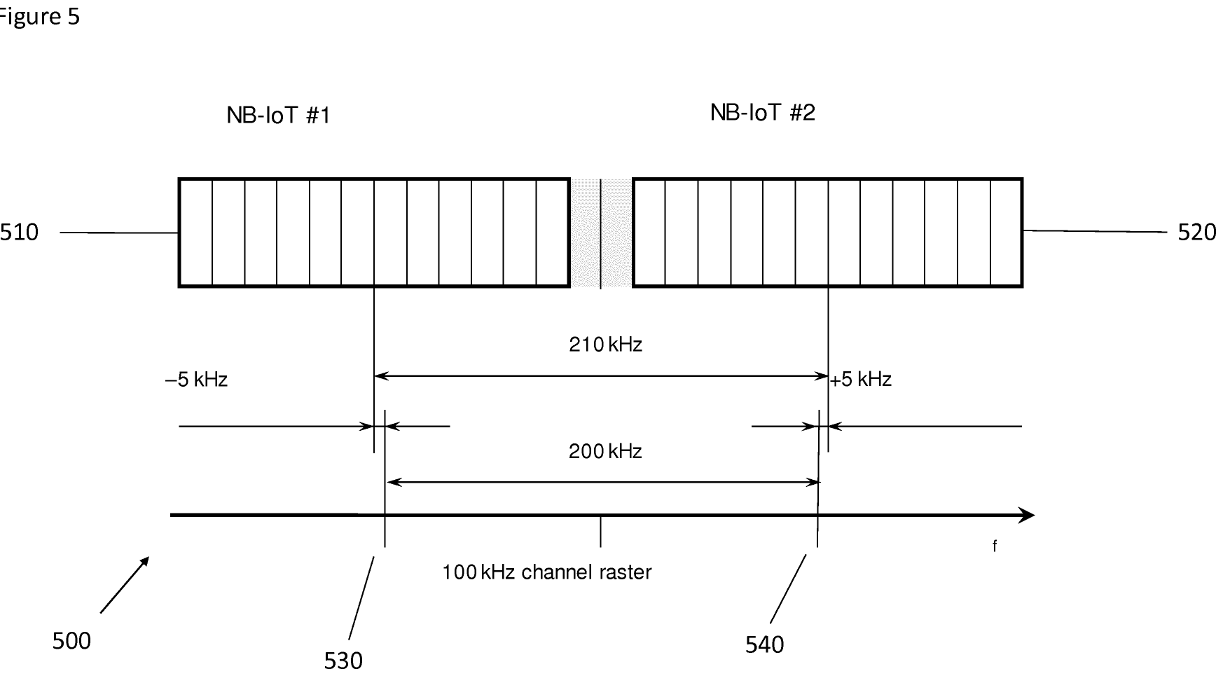

Reference is made to FIG. 5, which shows another example of the relative frequencies at which two carrier signals may be transmitted. The figure shows a first carrier signal 510, and a second carrier signal 520. The first carrier signal 510 is positioned close to a first point 530 in the channel raster, with its centre offset from the first point 540 by a first amount which is within the allowable threshold. In this example, the first amount is −5 kHz, which is within the allowable threshold for NB-IoT of ±7.5 kHz. The second carrier signal 520 is positioned close to a second point 540, with its centre offset from the second point 540 by a second amount which is within the allowable threshold. In this example, the second amount is +5 kHz, which is within the allowable threshold for NB-IoT of ±7.5 kHz. Thus in this example, the requirement that each carrier must be positioned within an allowable threshold from a point in the channel raster is met.

The offsets from the points in the channel raster are such that the distance between the centre of the first carrier signal 510 and the centre of the second carrier signal 520 are a multiple of the bandwidth allocated for each subcarrier. In this example, the distance between these centres is 210 kHz, which is a multiple of 15 kHz, the bandwidth allocated for each subcarrier in both NB-IoT and LTE. Therefore, both of the two requirements described above are met.

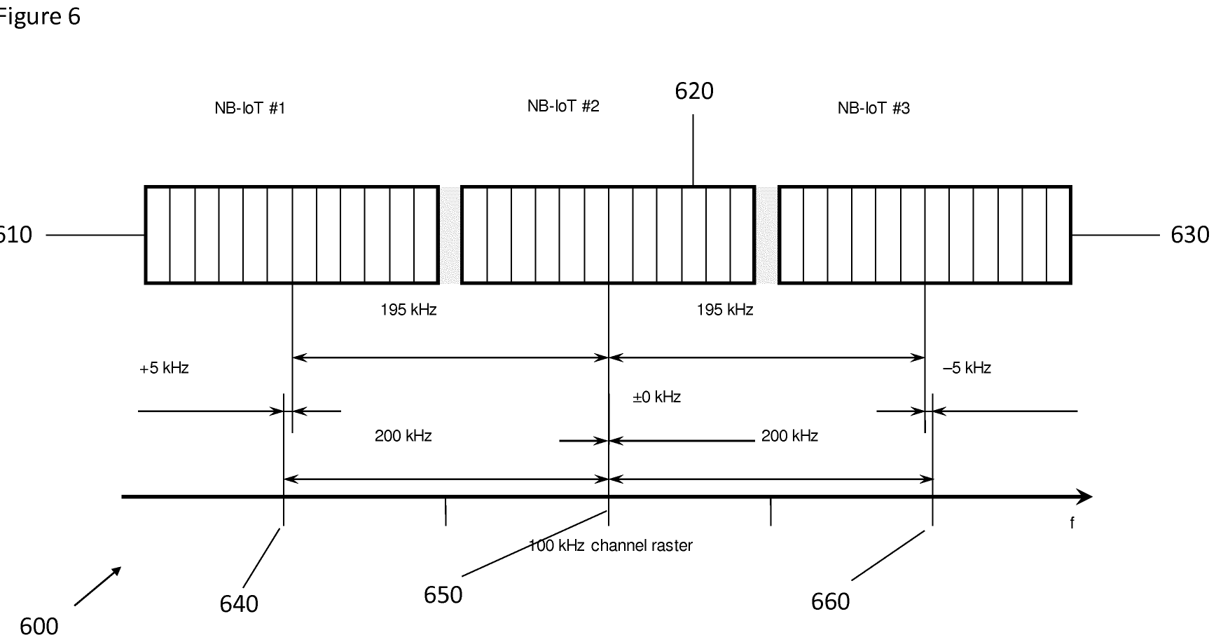

Reference is made to FIG. 6, which shows another example of the relative frequencies at which three adjacent carrier signals may be transmitted. The figure shows a first carrier signal 610, a second carrier signal 620, and a third carrier signal 630. The centre of the first carrier signal 610 is positioned close to a first point 640 in the channel raster, with its centre offset from the first point 640 by a first amount which is within the allowable threshold. In this example, the first amount is +5 kHz, which is within the allowable threshold for NB-IoT of ±7.5 kHz. The centre of the second carrier signal 620 is positioned at a second point 650. In this example, the offset between the centre of the second carrier signal 620 and the second point 650 is negligible or approximately zero. The centre of the third carrier signal 630 is positioned close to a third point 660 in the channel raster, with its centre offset from the third point 660 by a third amount which is within the allowable threshold. In this example, the third amount is −5 kHz, which is within the allowable threshold for NB-IoT of ±7.5 kHz. Thus in this example, the requirement that each carrier must be positioned within an allowable threshold from a point in the channel raster is met.

The offsets from the points in the channel raster are such that the distance between the centre of the first carrier signal 610 and the centre of the second carrier signal 620 and the distance between the centre of the second carrier signal 620 and the centre of the third carrier signal 630 are both a multiple of the bandwidth allocated for each subcarrier. In this example, these two distances are equal to 195 kHz, which is a multiple of 15 kHz, the bandwidth allocated for each subcarrier in both NB-IoT and LTE. Therefore, both of the two requirements described above are met.

Therefore, in some embodiments the offsets of +5 kHz, 0 kHz, and −5 kHz may be used for a sequence of adjacent carrier signals, where a first carrier signal in the sequence has an offset of +5kHz from its nearest channel raster point, the second carrier signal in the sequence has an offset of 0 kHz from its nearest channel raster point, and the third carrier signal in the sequence has an offset of −5kHz from its nearest channel raster point. This sequence may be repeated for any number of carriers.

In other embodiments, the offsets of −2.5 kHz, 0 kHz, and +2.5 kHz may be used for a sequence of adjacent carrier signals, where a first carrier signal in the sequence has an offset of −2.5 kHz from its nearest channel raster point, the second carrier signal in the sequence has an offset of 0 kHz from its nearest channel raster point, and the third carrier signal in the sequence has an offset of +2.5 kHz from its nearest channel raster point. This sequence may be repeated for any number of carriers.

The scheme given above in FIG. 4, in which the offset (i.e. ±2.5 kHz) from both points in the channel raster is significantly less than the threshold (i.e. ±7.5 kHz) may be preferred in the casein which there are only two adjacent carrier signals. In this case, it is possible to minimise the offset from the points in the channel raster, remaining well within the allowable threshold, whilst also meeting the requirement that the distance between the centres be a multiple of the subcarrier bandwidth.

The scheme given above in FIG. 6, in which offsets from the points are either 0 kHz or ±5 kHz, may be preferred in the case in which there are three adjacent carrier signals.

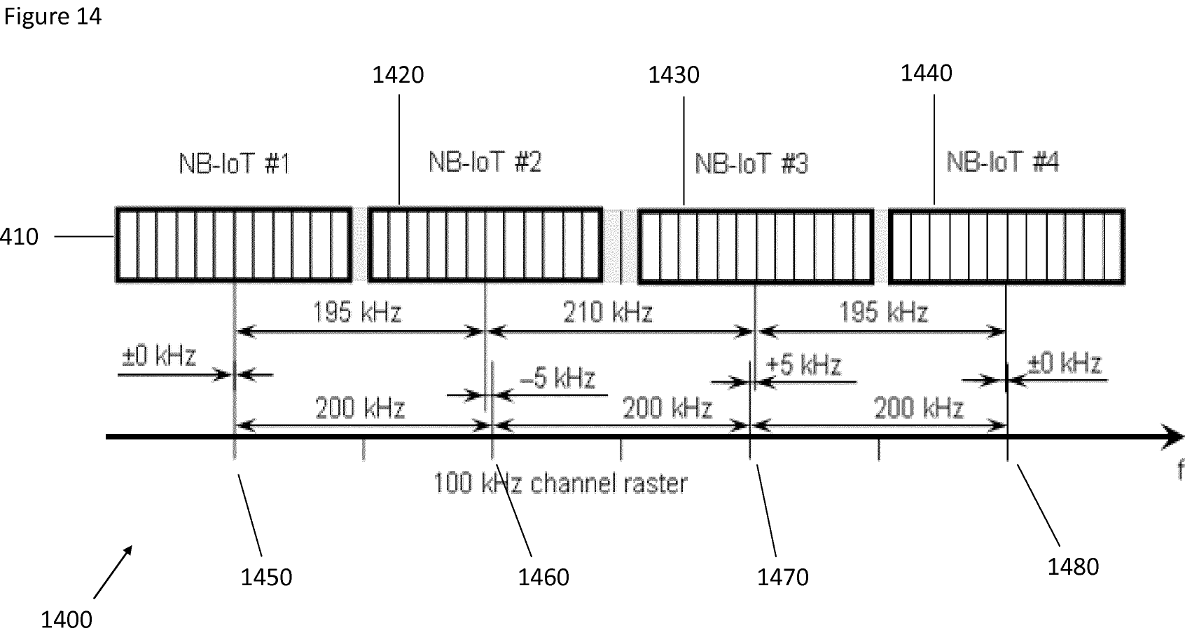

Reference is made to FIG. 14, which shows an example of the relative frequencies at which four adjacent carrier signals may be transmitted. The figure shows a first carrier signal 1410, a second carrier signal 1420, a third carrier signal 1430, and a fourth carrier signal 1440. The first carrier signal 1410 is centred at a first point 1450 in the channel raster. The centre of the second carrier signal 1420 is positioned close to a second point 1460. In this example, the offset is −5 kHz, which is within the allowable threshold for NB-IoT of ±7.5 kHz. The centre of the third carrier signal 1430 is positioned close to a third point 1470 in the channel raster, with its centre offset from the third point 1470 by a third amount which is within the allowable threshold. In this example, the third amount is +5 kHz, which is within the allowable threshold for NB-IoT of ±7.5 kHz. The fourth carrier signal 1440 is centred at a fourth point 1480 in the channel raster. Thus in this example, the requirement that each carrier must be positioned within an allowable threshold from a point in the channel raster is met.

As in previous examples, the distances between each of the centres of the four carrier signals is a multiple of 15 kHz.

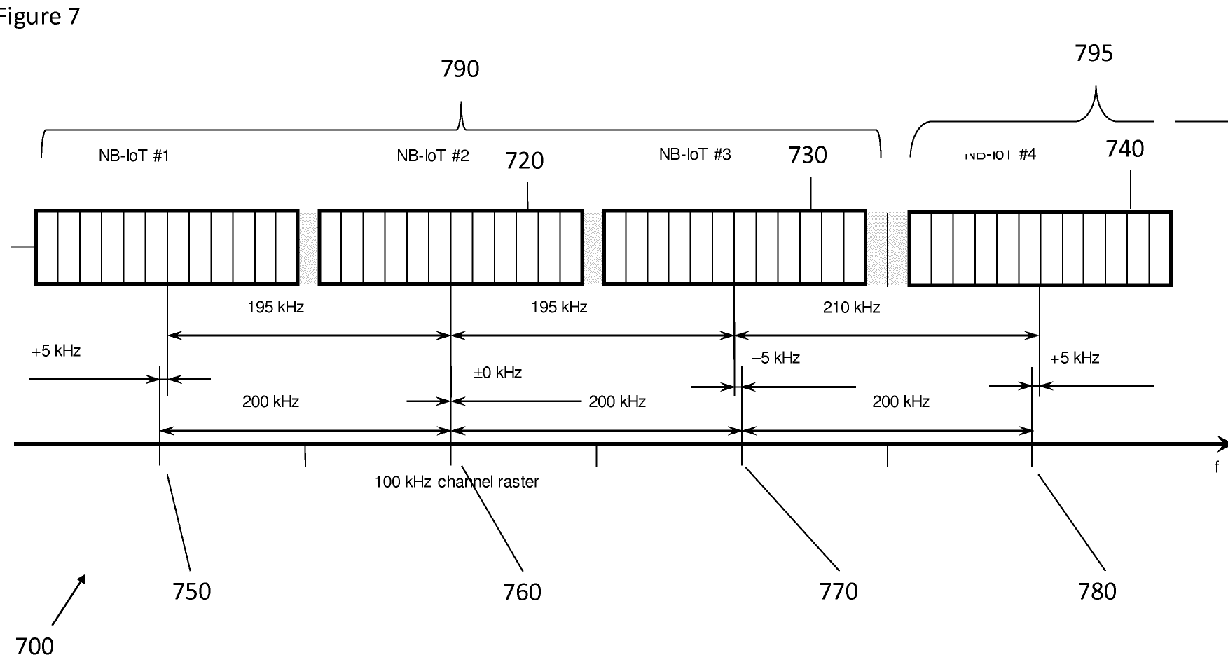

Reference is made to FIG. 7, which shows another example of the relative frequencies at which four adjacent carrier signals may be transmitted. The figure shows a first carrier signal 710, a second carrier signal 720, and a third carrier signal 730. The centre of the first carrier signal 710 is positioned close to a first point 750 in the channel raster, with its centre offset from the first point 750 by a first amount which is within the allowable threshold. In this example, the first amount is +5 kHz, which is within the allowable threshold for NB-IoT of ±7.5 kHz. The centre of the second carrier signal 720 is positioned at a second point 760. In this example, the offset between the centre of the carrier signal 720 and the second point is negligible or approximately zero. The centre of the third carrier signal 730 is positioned close to a third point 770 in the channel raster, with its centre offset from the third point 770 by a third amount which is within the allowable threshold. In this example, the third amount is −5 kHz, which is within the allowable threshold for NB-IoT of ±7.5 kHz. The centre of the fourth carrier signal 740 is positioned close to a fourth point 780 in the channel raster, with its centre offset from the fourth point 780 by a fourth amount which is within the allowable threshold. In this example, the fourth amount is +5 kHz, which is within the allowable threshold for NB-IoT of ±7.5 kHz. Thus in this example, the requirement that each carrier must be positioned within an allowable threshold from a point in the channel raster is met.

The offsets from the points in the channel raster are such that the distances between the centres of each neighbouring pair of carrier signals is a multiple of the bandwidth allocated for each subcarrier. In this example, the distance between the centres of the first 710 and second 720 signals and between the centres of the second 720 and third 730 signals is 195 kHz. The distance between the centres of the third 730 and fourth 740 signals is 210 kHz. Both 195 kHz and 210 kHz are multiples of 15 kHz, the bandwidth allocated for each subcarrier in both NB-IoT and LTE. Therefore, both of the two requirements described above are met.

In some embodiments, the arrangement of the carrier signals may follow a repeating pattern. The pattern may involve using a set of offsets from the channel raster points for a first set of adjacent carrier signals and then using the same set of offsets for a second set of adjacent carrier signals. The second set being adjacent to the first set. Each set may comprise three carrier signals.

An example of a first set 790 of adjacent carrier signals is shown in FIG. 7. The centre of the first carrier signal 710 is offset from a channel raster point 750 by +5 kHz, the centre of the second carrier signal 720 is offset by 0 kHz from a channel raster point 760, and the centre of the third carrier signal 730 is offset by −5 kHz from a channel raster point 770. Therefore, the set of offsets used by the first set 790 of adjacent carrier signals is {−5 kHz, 0 kHz, +5 kHz}. This same set of offsets may be used for positioning the carrier signals of the second set 795 of adjacent carrier signals, of which only one carrier signal 740 is shown in the figure.

Using such a repeating pattern for the positioning of the carrier signals allow a large number of carrier signals to be accommodated whilst allowing the two requirements of alignment with the channel raster and the subcarrier grid to be met.

In some embodiments, the guard bands between adjacent carriers may be removed. The above examples, describes cases where the distances between the centres of adjacent carrier signals are 195 kHz and 210 kHz. However, this could be reduced to 180 kHz.

To reduce the distances between the centres of adjacent carrier signals (e.g. to 180 kHz) may involve increasing the offsets from the channel raster beyond allowable thresholds (e.g. to 7.5 kHz in NB-IoT). In order to overcome this problem and to be able to reduce the distances between two adjacent carriers, the first channel signal may be configured as an anchor carrier. An anchor carrier is a carrier for facilitating UE initial synchronisation and must be placed near the points in the channel raster, i.e. within the threshold discussed above (e.g. 7.5 kHz). The anchor carrier must be within this threshold so that the UE, which is only required to search for a carrier on a 100 kHz raster, can locate the anchor carrier.

The second carrier signal, and potentially further remaining carrier signals, may be a non-anchor carrier or secondary carrier. A UE, which has located the first carrier signal and is able to perform the necessary initialisation for this carrier, may then perform a cell reselection technique so as to locate and perform the necessary initialisation for the second carrier signal. In some embodiments, there may be no threshold distance required for the second carrier signal. In other embodiments, the distance between the centre of the second carrier signal and a point in the channel raster must be less than a second threshold, which is greater than the first threshold, which applies to the first carrier signal. For example, the second threshold may be −50 kHz and +45 kHz. The centre of the non-anchor carrier take any position within this threshold in steps of 5 kHz from the threshold boundaries.

By allowing a larger threshold or no threshold for non-anchor/secondary carriers, there is more freedom to position the non-anchor/secondary carriers, whilst still meeting the channel raster requirement that is required by the UE for initialisation. This extra freedom allows, the distance between two adjacent carrier signals to be reduced.

The cell search and cell reselection process may involve the following steps. In Downlink, the UE detects the position of the anchor (NB-IoT) carrier provided by the base station. Synchronization and other procedures are performed. For UL the UE takes the default duplex distance or is notified via DL about a different duplex distance. Hence UL placement is independent of DL. UE may be notified to use a non-anchor carrier. DL frequency position of the non-anchor carrier (virtually any offset to channel raster, but still quantified in steps of 5 kHz, which makes sense if the 15 kHz grid shall be considered) is provided from the anchor carrier via DL.

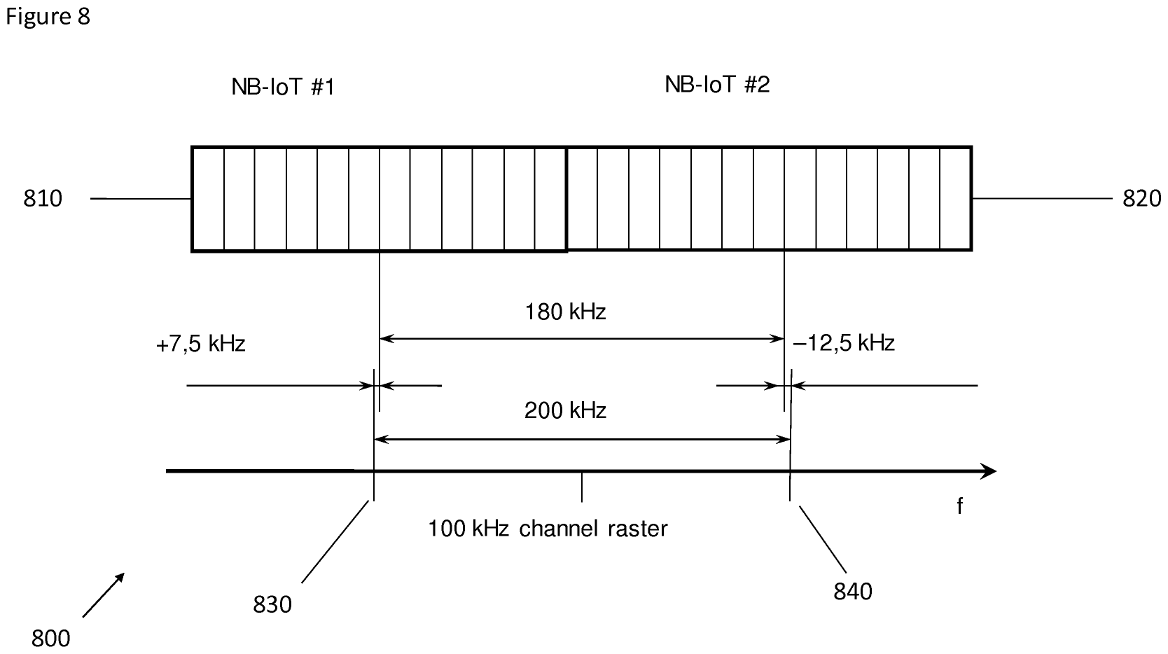

Reference is made to FIG. 8 which shows an example of the relative frequencies at which two carrier signals may be transmitted. The figure shows a first carrier signal 810, which is an anchor carrier, and a second carrier signal 820, which is a non-anchor/secondary carrier. The first carrier signal 810 is positioned close to a first point 830 in the channel raster, with its centre offset from the first point 830 by a first amount which is within a first allowable threshold which applies for anchor carriers. In this example, the first amount is +7.5 kHz, which is within the allowable threshold for NB-IoT of ±7.5 kHz. The second carrier signal 820 is positioned close to a second point 840, with its centre offset from the second point 840 by a second amount. In this example, the second amount is −12.5 kHz, which is within the allowable threshold for NB-IoT non anchor carriers of ±47.5 kHz. Thus in this example, the requirement that each carrier must be positioned within an allowable threshold from a point in the channel raster is met.

In this example, the first amount and second amount may alternatively be +5 kHz and −15 kHz, respectively.

The offsets from the points in the channel raster are such that the distance between the centre of the first carrier signal 810 and the centre of the second carrier signal 820 is a multiple of the bandwidth allocated for each subcarrier. In this example, the distance between these centres is 180 kHz, which is a multiple of 15 kHz, the bandwidth allocated for each subcarrier in both NB-IoT and LTE. Therefore, both of the two requirements described above are met.

This scheme is advantageous in that the distance between the carriers is reduced, and less of the spectrum is wasted. In some cases, the guardband may be eliminated such that there is no gap between the carrier signals.

As noted above, the subcarriers of different carrier signals may not always have the same bandwidth. For example, for two adjacent carrier signals, the first carrier signal may comprise subcarriers having a first bandwidth (e.g. 3.75 kHz) whilst the second carrier signal may comprise subcarriers having a second bandwidth (e.g. 15 kHz). The use of different subcarrier widths for two adjacent carrier signals, may lead to increased interference between these carrier signals due, at least in part, to differences in the frequency of symbol transitions. It may that a sequence of carrier signals along the frequency spectrum comprises a first set of carrier signals and a second set of carrier signals adjacent to each other. These sets may utilize subcarriers of different bandwidths. To reduce the interference, between these sets of carriers, the distance between them may be increased. The distance may be such that there is at least two points of the channel raster present between the first set and the second set. The at least two points may be present in a guardband between the first set and second set. The distance between the centre points of the first carrier and the second carrier may be 300 kHz.

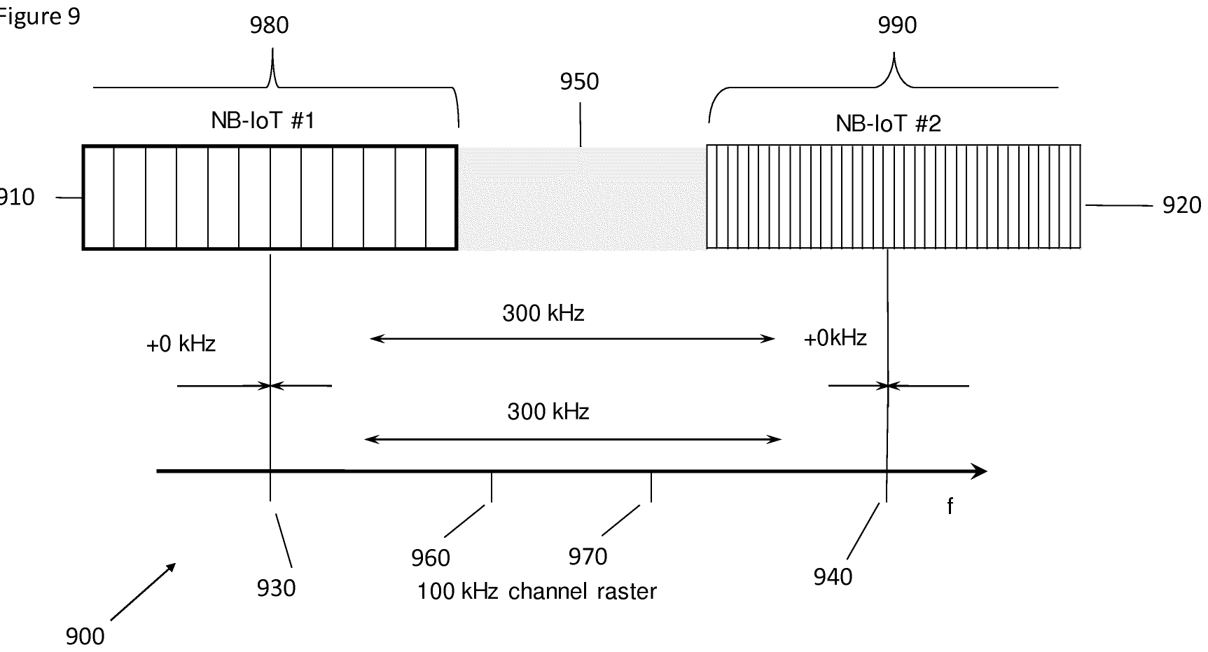

Reference is made to FIG. 9, which shows an example of the relative frequencies at which two carrier signals may be transmitted. The figure shows a first carrier signal 910 belonging to a first set 980 of carrier signals (of which only the first carrier signal 910 is shown), which has subcarriers of a first bandwidth (e.g. 15 kHz), and a second carrier signal 920 belonging to a second set 990 of carrier signals (of which only the second carrier signal 920 is shown), which has subcarriers of a second bandwidth (e.g. 3.75 kHz). The first set of carrier signals and/or the second set of carrier signals may comprise any of the sets of carrier signals as described with reference to FIGS. 4 to 6.

The first carrier 910 may be centred at a first point 930 in the channel raster. The second carrier 920 may be centred at a second point 940 in the channel raster. Alternatively, the carriers may be offset from the channel raster points. The figure also shows a guardband 950 between the two sets of carriers. The guardband may be 120 kHz wide. The guardband is wide enough such that at least two channel raster points 960, 970 are present between the first point 930 and the second point 940. These channel raster points may be located in the guardband.

The additional separation between the first carrier signal 910 and the second carrier signal 920 is such that the interference between the two carrier signals is reduced.

A prerequisite for orthogonality between the transmitted subcarriers, and hence reduced interference between them, is good time alignment between symbols of adjacent standalone NB-IoT carrier signals. This may be achieved by having the carriers transmitted by the same transmission equipment, e.g. a radio unit.

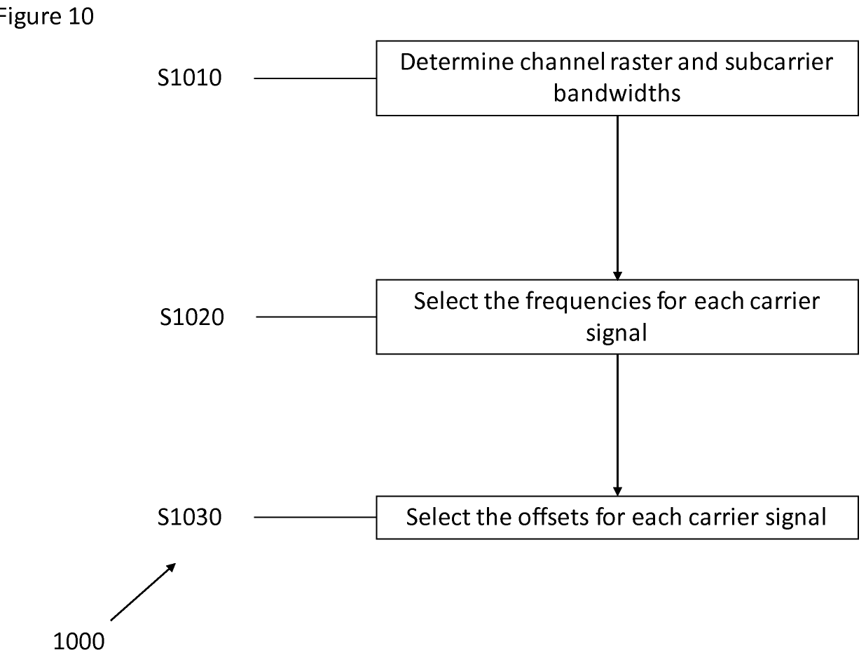

Reference is made to FIG. 10, which shows a series of steps that may be performed by an apparatus for allocating the carrier frequencies to be used for transmission. The apparatus may be a radio network controller. The apparatus may be a control apparatus 108, 109. The apparatus may be part of a base station 120, 118, 116, 106, 107. The carrier frequencies may be allocated for a cell, microcell, picocell, femtocell or the like and neighbouring cells may have carrier frequencies independently allocated than for their neighbours. Alternatively, a plurality of neighbouring cells may utilise and share a set of carrier frequencies so as to reduce interference between neighbouring cells, with the carrier frequencies transmitted in one cell being dependent upon the transmissions of the neighbouring cells.

The transmitter may be UE, a base station, or another form of apparatus. It would be understood by the person skilled in the art that not all embodiments include all of these steps but that some of these steps are optional and may be omitted in some embodiments.

At S1010, the apparatus may determine the criteria that must be met. Specifically, it may determines the channel raster step size, and the subcarrier bandwidth of the carrier signals.

At S1020, the apparatus selects the frequencies for transmitting each carrier signal. These frequencies are selected so that the carrier signals are centred at frequencies within a threshold distance of channel raster points and at frequencies separated by a multiple of the subcarrier bandwidths. The apparatus may determine which carrier signals are to be used for transmission to/from which devices. The apparatus may determine which carrier signals are to be allocated to which cells. The apparatus may determine which carrier signals are to be uplink carrier signals and which downlink.

At S1030, the apparatus causes the transmission of an indication of the frequencies allocated for the different carrier signals to one or more transmitting devices. These transmitting devices may be UE or base stations.

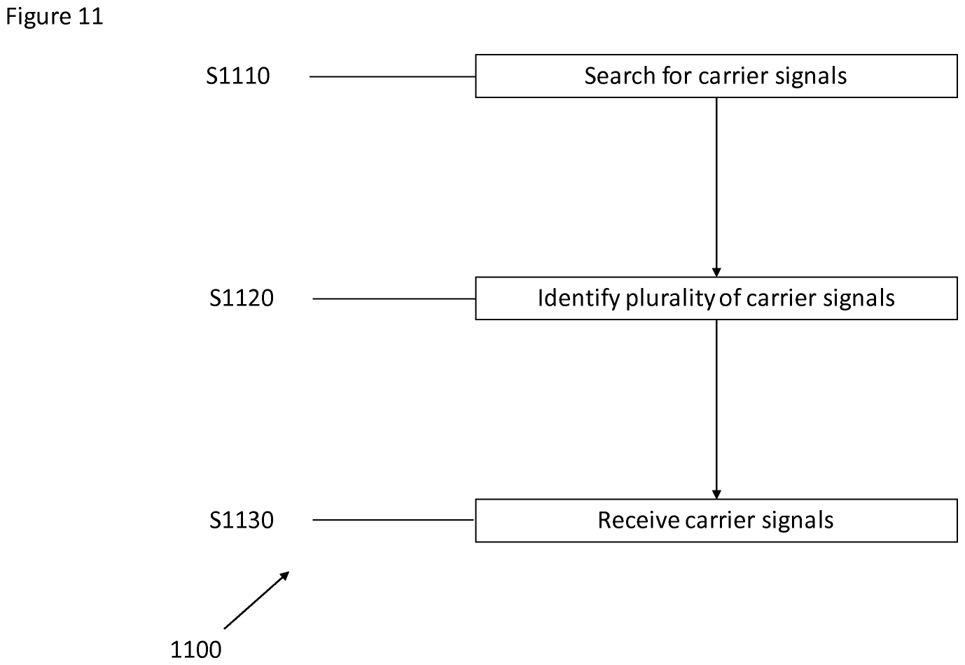

Reference is made to FIG. 11, which shows a series of steps that may be performed by a receiver of the carrier signals. The receiver may be a UE or another form of apparatus. It would be understood by the person skilled in the art that not all embodiments include all of these steps but that some of these steps are optional and may be omitted in some embodiments.

At S1110, the apparatus performs a search for carrier signals. The search is carried out on a channel raster, whereby the apparatus searches for a carrier signal on every point in the channel raster.

At S1120, the apparatus identifies the carrier signals in its search and performs any necessary initialisation steps in preparation for reception of the carrier signals.

At S1130, the apparatus receives the carrier signals which it has identified.

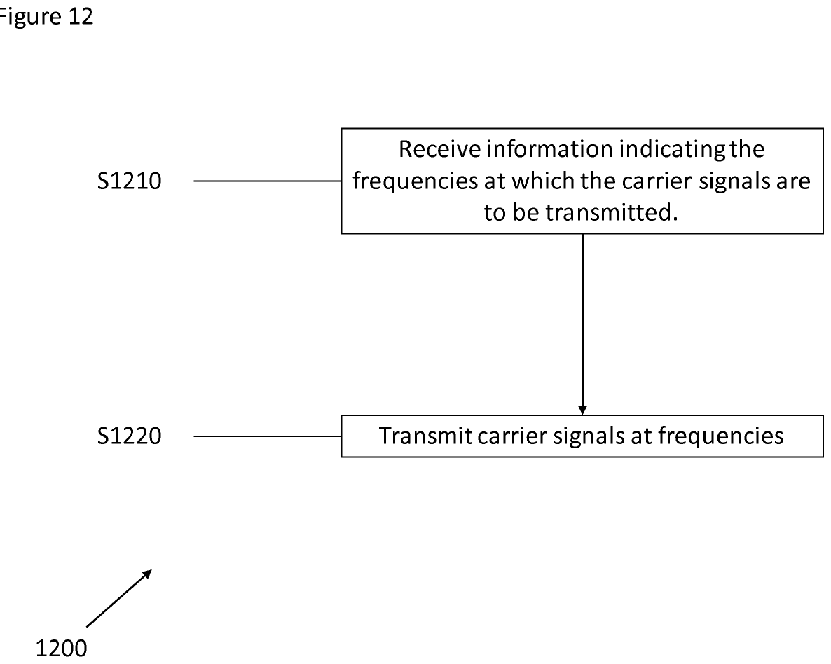

Reference is made to FIG. 12, which shows a series of steps that may be performed by a transmitter of the carrier signals. The transmitter may be a base station, a UE or another form of apparatus. It would be understood by the person skilled in the art that not all embodiments include all of these steps but that some of these steps are optional and may be omitted in some embodiments.

At S1210, the apparatus is configured to transmit information indicating the frequencies at which one or more of the plurality of carrier signals are to be transmitted. This information may be received from a control apparatus of the network, e.g. a radio network controller. The information may include an indication of the frequency at which the first carrier signal is centred only. The information may also include an indication of the frequency at which the second carrier signal is also centred. In some embodiment, the transmitting apparatus may not receive the indication, but may allocate the frequencies at which carrier signals are to be transmitted. In this case the transmitter may perform some or all of the steps S1010 to S1030 of the method 1000 illustrated in FIG. 10.

At S1220, the transmitter transmits one or more carrier signals of the plurality of carrier signals. The transmitter may transmit only the first carrier signal. The transmitter may transmit the second carrier signals at frequencies adjacent to the first carrier signal. The transmitter may transmit all of the plurality of carrier signals.

It is noted that whilst embodiments have been described in relation to one example of a standalone LTE network, similar principles maybe applied in relation to other examples of standalone 3G, LTE or 5G networks. It should be noted that other embodiments may be based on other cellular technology other than LTE or on variants of LTE. It should also be noted that other embodiments may be based on standards other than NB-IoT or on variants of NB-IoT. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

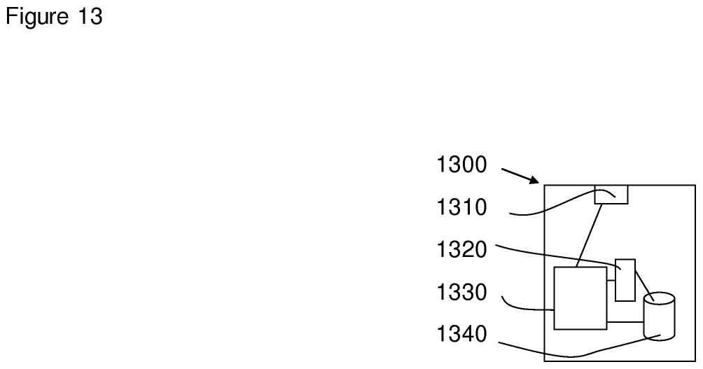

The method may additionally be implemented in a control apparatus as shown in FIG. 13. The method may be implemented in a single processor 201 or control apparatus or across more than one processor or control apparatus. FIG. 13 shows an example of a control apparatus 1300 for a communication system, for example to be coupled to and/or for controlling a station of an access system, such as a RAN node, e.g. a base station, (e) node B, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 1300 can be arranged to provide control on communications in the service area of the system. The control apparatus 1300 comprises at least one memory 1310, at least one data processing unit 1320, 1330 and an input/output interface 1340. Via the interface the control apparatus can be coupled to a receiver and a transmitter of the base station. The receiver and/or the transmitter may be implemented as a radio front end or a remote radio head. For example, the control apparatus 1300 or processor 201 can be configured to execute an appropriate software code to provide the control functions.

Control functions may comprise causing the transmission by a first entity of a first carrier signal of a plurality of carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

Alternatively, or in addition, control functions may comprise performing a search for at least one carrier signals using a channel raster; receiving at least a first carrier signal of a plurality of carrier signals, the first carrier signal being centered at a first frequency offset from a first channel raster point by an amount which is greater than 0 and less than a first threshold, wherein a second carrier signal is adjacent the first carrier signal and centered at a second frequency at or within a second threshold of a second channel raster, both the first carrier signal and the second carrier signal comprise a plurality of subcarriers of a defined bandwidth, and the first frequency and the second frequency differ by an amount substantially equal to a multiple of the defined bandwidth.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

Indeed there is a further embodiment comprising a combination of one or more embodiments with any of the other embodiments previously discussed.

1. An apparatus comprising:
at least one processor and at least one memory including computer program code, the at least one memory and the computer program code configured to, with the at least one processor, cause the apparatus at least to:
transmit by a first entity a first carrier signal of a plurality of standalone carrier signals, the first carrier signal being centered at a first frequency offset from a first channel raster point by an amount which is greater than zero and less than a first threshold, wherein a second carrier signal is adjacent to the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

2. The apparatus according to claim 1, wherein the computer program code is further configured to cause the apparatus to transmit the first entity the second carrier signal.

3. An apparatus comprising:
at least one processor and at least one memory including computer program code, the at least one memory and the computer program code configured to, with the at least one processor, cause the apparatus at least to:
perform a search for at least one carrier signals using a channel raster; and
receive at least a first carrier signal of a plurality of standalone carrier signals, the first carrier signal being centered at a first frequency offset from a first channel raster point by an amount which is greater than zero and less than a first threshold, wherein a second carrier signal is adjacent to the first carrier signal and centered at a second frequency at or within a second threshold of a second channel raster, both the first carrier signal and the second carrier signal comprise a plurality of subcarriers of a defined bandwidth, and the first frequency and the second frequency differ by an amount substantially equal to a multiple of the defined bandwidth.

4. The apparatus according to claim 3, wherein the first threshold is the same as the second threshold.

5. The apparatus according to claim 3, wherein the second frequency is offset from a second channel raster point by a second amount which is greater than zero.

6. The apparatus according to claim 3, wherein at least one of the plurality of carrier signals is centered at a point of the channel raster.

7. The apparatus according to claim 3, wherein the first frequency is offset from the first channel raster point by about +5 kHz and the second frequency is offset from the second channel raster point by about −5 kHz.

8. The apparatus according to claim 3, wherein the plurality of carrier signals comprises a third carrier signal adjacent the second carrier signal and centered at a third frequency within a third threshold distance from a third channel raster point.

9. The apparatus according to claim 3, wherein the plurality of carrier signals comprises a sequence of carrier signals, where the sequence of carrier signals uses a repeating sequence of offsets from the channel raster points on a frequency spectrum.

10. The apparatus according to claim 8:
wherein the plurality of carrier signals comprises a plurality of sets of carrier signals, each set comprising three carrier signals having a relative arrangement on a frequency spectrum matching a relative arrangement of the first carrier signal, the second carrier signal, and the third carrier signal.

11. The apparatus according to claim 3: preceding claim,
wherein the plurality of carrier signals comprises a first set of carrier signals comprising the first carrier signal and the second carrier signal;
wherein the plurality of carrier signals comprises a second set of carrier signals adjacent the first set and comprising subcarriers of a second defined bandwidth different to the defined bandwidth, and
wherein there are at least two channel raster points between the first set of carrier signals and the second set of carrier signals.

12. The apparatus according to claim 3, wherein the first carrier signal and the second carrier signal are anchor carrier signals.

13. The apparatus according to claim 4, wherein the first carrier signal is an anchor carrier signal, and the second carrier signal is a non-anchor carrier signal,
wherein the first threshold distance is smaller than the second threshold distance.

14. The apparatus according to claim 13, wherein the first frequency is offset from the first channel raster point and the second frequency is offset from the second channel raster point

15. The apparatus according to claim 13, wherein the second threshold is −50 kHz and +45 kHz from the second channel raster point, wherein the second frequency is positioned at a multiple of 5 kHz from the boundaries of the second threshold.

16. The apparatus according to claim 3, wherein the plurality of carrier signals are arranged in a sequence, wherein the each of the plurality of carrier signals is offset from its nearest channel raster point by an amount less than a defined threshold, wherein the offsets of the plurality of carrier signals alternate between negative and positive offsets in the sequence.

17. A computer program product for a computer, comprising software code portions for performing the steps of claim 3, when the program is run on the computer.

18. A method comprising:
transmitting a first carrier signal of a plurality of standalone carrier signals, the first carrier signal being centered at a first frequency offset from a first channel raster point by an amount which is greater than zero and less than a first threshold, wherein a second carrier signal is adjacent to the first carrier signal and centered at a second frequency at or within a second threshold of a second channel raster, both the first carrier signal and the second carrier signal comprising a plurality of subcarriers of a defined bandwidth, and the first frequency and the second frequency differ by an amount substantially equal to a multiple of the defined bandwidth.

19. A method comprising:
performing a search for at least one carrier signals using a channel raster; and
receiving at least a first carrier signal of a plurality of standalone carrier signals, the first carrier signal being centered at a first frequency offset from a first channel raster point by an amount which is greater than zero and less than a first threshold, wherein a second carrier signal is adjacent to the first carrier signal and centered at a second frequency at or within a second threshold of a second channel raster, both the first carrier signal and the second carrier signal comprise a plurality of subcarriers of a defined bandwidth, and the first frequency and the second frequency differ by an amount substantially equal to a multiple of the defined bandwidth.
